(19) United States
(12) Patent Application Publication
(10) Pub. No.: US 2025/0278488 A1
(43) Pub. Date: Sep. 4, 2025

(54) CHERRY PICKING RESTORE USING INFECTED FILE LIST

(71) Applicant: Dell Products L.P., Round Rock, TX (US)

(72) Inventor: Gerald M. Jourdain, Hudson, NH (US)

(21) Appl. No.: 18/595,028

(22) Filed: Mar. 4, 2024

(51) Int. Cl. G06F 21/56; G06F 11/14; G06F 21/53

(52) U.S. Cl. CPC G06F 21/565; G06F 11/1469; G06F 21/53; G06F 2201/80; G06F 2221/034

(57) ABSTRACT

One example method includes selecting a backup for restoration to a target asset, when an examination of the backup reveals that the backup is associated with an infected file list, restoring the backup to a sandbox, in the sandbox, zeroing out any infected blocks of any infected files of the backup that are listed in the infected file list, restoring the backup from the sandbox to the target asset, and/or restoring to the target asset, a respective last known good version of selected ones of the infected files.

### FIELD OF THE INVENTION

Embodiments of the present invention generally relate to data protection. More particularly, at least some embodiments of the invention relate to systems, hardware, software, computer-readable media, and methods, for restoring selected portions of backed up data, guided by an infected file list.

### BACKGROUND

Data protection is often thought of being synonymous with data backup. The purpose of a backup is to be able to recover from a disaster usually referred to as a Disaster Recovery (DR) event. When a ransomware attack occurs, it often goes undetected, and backups can be made of the infected asset. In such a circumstance, an ideal approach to recover might be to restore from an unaffected backup. In practice however, this approach is not realistic since it is likely that that the latest infected backups also have valuable, newer, uninfected data.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a method and architecture, according to one embodiment.

FIG. 2 discloses aspects of an example data backup structure according to one embodiment.

FIG. 3 discloses aspects of an example method according to one embodiment.

FIG. 4 discloses aspects of a computing entity configured and operable to perform any of the disclosed methods, processes, and operations.

### DETAILED DESCRIPTION OF SOME EXAMPLE EMBODIMENTS

Embodiments of the present invention generally relate to data protection. More particularly, at least some embodiments of the invention relate to systems, hardware, software, computer-readable media, and methods, for restoring selected portions of backed up data, guided by an infected file list.

One example embodiment of the invention comprises a method for restoring backed up data. One example of such a method comprises the operations: using an infected file list to identify those files in a backup that are known or suspected to be infected; restoring, from the backup, all uninfected files; and for selected ones of the infected files in the backup, restoring a last known good copy of each of the selected files. In an embodiment, restoration of the last known good copies may be omitted, and only the uninfected files of the backup, which may be the latest infected backup, are restored.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiments is that files may be selectively restored from a backup based on the status of those files as infected, or not. An embodiment may enable identification of those files of a backup that are known or suspected to be compromised. An embodiment may identify, with a high level of confidence, files, such as may be elements of a backup, known or suspected to be compromised. An embodiment may enable selective restoration of only uninfected files and/or the last known good version of infected files. Various other advantages of one or more example embodiments will be apparent from this disclosure.

### A. ASPECTS OF AN EXAMPLE ARCHITECTURE AND ENVIRONMENT

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

### B. OVERVIEW OF ASPECTS OF AN EXAMPLE EMBODIMENT

In the event of a disaster or other problem, an ideal data recovery approach might be to restore all the data from a backup that has been unaffected by the disaster, preferably this would be the last backup taken before the disaster occurred. In practice however, this circumstance does not often present itself. That is, backups almost invariably include some infected files and/or other infected data with the result that, after occurrence of a problem, some of the data in a backup from which a restore is to be taken is likely to be infected. Thus, one embodiment comprises a more pragmatic approach, which may be referred to herein as a two pass restore. In an embodiment, the first pass may restore all the uninfected data from the latest backup, and the second pass, possibly performed subsequent to the first, may recover infected data from the last known uninfected copy on a previous backup.

An embodiment may comprise various features to enable implementation of such a two pass restore. For example, a backup may be provided with a changed file list indicating which files were changed between that backup and the immediately preceding backup, or another prior backup. Additionally, an embodiment may provide a potentially infected file list, or suspect file list, that is associated with the backup. Where this changed file list is computed with a high level and confidence, possibly as high as 100 percent confidence, the changed file list may reliably indicate which files are known or suspected to be infected. If, during a data protection process such as a backup operation, and infection was detected, then the infected file list may be updated with an entry that identifies the infected file. This detection may be implemented before/during performance of a backup or other data protection operation, or may be implemented after the data protection operation has been completed. In either case, the infected file list may be updated as a result of the detection operation, thus providing a high level of confidence that any and all infected files in the backup have been identified. Example methods for creating and using a changed file list, and a potentially infected file list, are disclosed in U.S. patent application Ser. No. 18/594,888, entitled BUILDING A POTENTIALLY INFECTED FILE LIST DURING DATA PROTECTION USING CHANGE BLOCK LIST (the ‘888 Application’) filed the same day herewith, and incorporated herein in its entirety by this reference.

In order to detect files suspected to be compromised, an embodiment may employ a file-by-file interrogation of an entire backup. This interrogation may be performed during backup, or after the backup has been completed. In this way, corruption may be identified with a high level confidence. With this level of confidence and the ability to detect infection both during and post processing, the integrity of a backup may be assured with a high level of credence.

In an embodiment, knowing which files of a backup have changed and, which files are known or suspected to be infected may enable at least two different ‘cherry-picking’ workflows. The first such workflow may comprise restoring all uninfected items, and then cherry-picking, or selecting on a file-by-file basis for example, from previous backups, last known good copies of one or more infected files. An embodiment of the second such workflow may comprise cherry-picking only uninfected files, from the latest infected backup, for restore.

### C. DETAILED DISCUSSION OF ASPECTS OF ONE OR MORE EXAMPLE EMBODIMENTS

Following is a discussion of aspects of one or more example embodiments. These embodiments are presented by way of illustration and are not intended to limit the scope of the invention in any way.

If during restore from a backup, an infected file list is encountered, an embodiment may provide the option to restore all content except the infected files. In one example of this approach, the backup may be restored to a clean area, sometimes referred to as a ‘sandbox.’ Once the backup is in the sandbox, the blocks of each infected file are zeroed out before restoring the backup to the asset. Upon completion of this restore, the list of infected files identified while the backup was in the sandbox may be looked up in previous backups until the last known good copy for each file is found. For each known good copy of an infected file, that good copy may then restored over the zeroed out infected file in the asset. If during a restore from a backup, an infected file list is encountered, a user may be presented an option of individual file restore to an alternate location. This alternation location restore may have knowledge of the infected file status and be able to warn the customer accordingly.

It is noted that as used herein, the term ‘asset’ refers to the source object that is being backed up or has been backed, such as, but not limited to, a laptop, a VM, NAS (network attached storage) device, or any other system and/or device that has data which may be targeted for protection in some way. In an embodiment, an asset may be backed up using a policy of some kind, either manual or on a scheduled frequency.

### C.1 Cherry Pick Restore

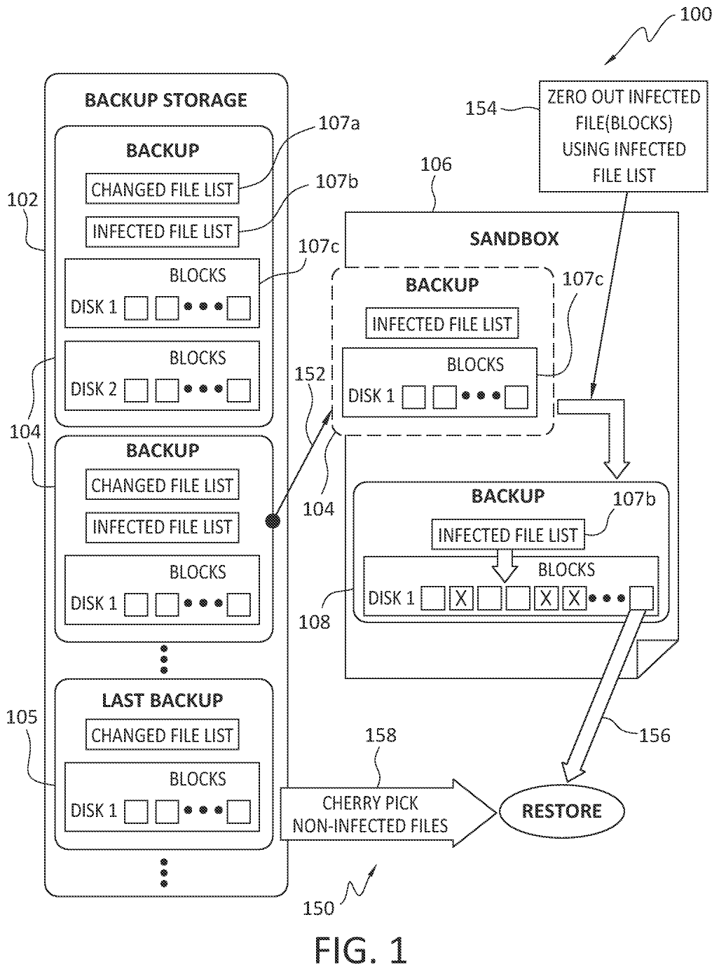

With attention now to FIG. 1, an example architecture 100 and associated method 150 are disclosed. As shown, the example architecture 100 may comprise a backup storage site 102 holding one or more backups 104, each of which may have been taken at a different respective time. A backup 105 may be the last backup that was taken before the occurrence of a disaster or other problem. The example architecture 100 may also comprise a sandbox 106 that is able to receive backups 104 from the backup storage site 102

Each of the backups 104 may further be associated with, and include, a respective changed file list 107a, and an infected file list 107b. As well, the backups 104 may each further comprise a respective block list 107c that indicates which blocks belong to which files of the backups 104.

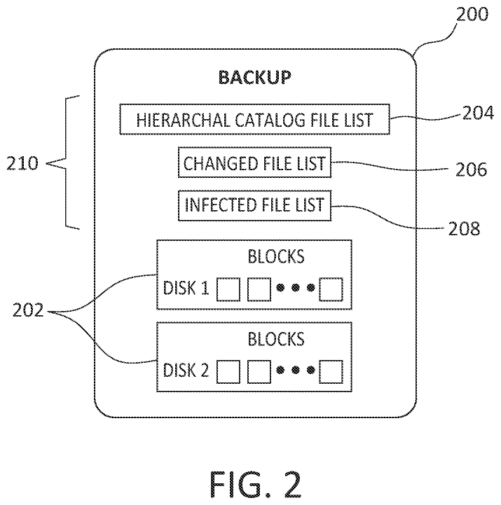

As shown in FIG. 2, a backup 104 having one or more files known or suspected to be infected, may be restored 152 to the sandbox 106. The determination of such files as being known or suspected to be infected may be made based on examination of the infected file list 107b associated with that particular backup 104.

After the backup 104 has been restored to the sandbox 106, the block list 107c for each infected file in the backup 104 may be examined, and any blocks known or suspected to be infected may be zeroed out 154. Since the infected file list 107b may be a subset of the changed file list 107a, the backup 104 that is ultimately sent to the sandbox 106 may include only the infected files in the infected file list 107b for that backup 104. There may be no need to restore the changed file list 107a, and/or any uninfected files, of the backup 104 to the sandbox 106.

After the infected block(s) of the infected files have been zeroed out 154, the backup 104 may then be restored 156 to the asset. Next, the list of infected files for that backup 104 may be examined, and prior backups reviewed, beginning with the most recent backup 105 to succeeding less recent backups, until the last known, that is, most recent, good copy of each of the infected files is found. Each most recent known good copy of an infected file may then be restored 158 over the zeroed out infected file in the asset.

### C.2 Data Structures

An embodiment may employ various data structures to help improve the self-describing nature of a backup, and thereby provide insight into the content of the backup. With reference now to FIG. 2, an example backup 200 according to one embodiment is disclosed. As shown, the backup 200 may comprise respective lists 202 of blocks for one or more files included in the backup. In an embodiment, each of the lists 202 may comprise one or more disk extents.

With continued reference to FIG. 2, the example backup 200 may comprise three discrete data structures, namely, a hierarchical catalog file list 204 which may also simply be referred to as a catalog file list, a changed file list 206 that lists files that have changed since the backup immediately preceding the backup 200, and an infected file list 208 that lists files known or suspected to be infected. In one embodiment, a single data structure 210 may be employed that comprises a hierarchical catalog file list, a changed file list, and an infected file list. The use of discrete data structures, however, may be advantageous as they may enable faster lookups of their content, and possibly more efficient usage of memory.

### C.3 Populating an Infected File List

In an embodiment, an infected file list may be created as disclosed in the '888 Application. An infected file list may comprise various fields for each suspect file and can be built during different points of the data protection process. In an embodiment, such fields may include, but are not limited to: (1) filename of the suspect file; (2) block numbers, possibly in disk extend format, associated with the suspect file; and, (3) an infected status of the suspect file, that is, a status indicator showing that the file is known or suspected to be infected.

### C.4 Building an Infected File List During Data Crawling

In an embodiment, an asset may be backed up using a crawling workflow, like NAS. During this work flow, the the asset may be enumerated and the hierarchal catalog may be built. As well, during this crawling phase, ransomware detection functionality may be implemented and the infected file list may be updated based on the outcome of the ransomware detection operations. An embodiment may integrate with virus detection software to read or otherwise examine suspect files and add those files to the infected file list.

### C.5 Building an Infected File List During Data Movement

In an embodiment, a backup process may be reading the blocks from the asset and writing the blocks to the destination backup device. During this workflow, the blocks may be translated, or mapped, to their associated filename, analyzed, and the filename then add to infected file list, if appropriate.

### C.6 Building an Infected File List Post Processing

In an embodiment, after the backup operation has been completed and the backup resides on the destination backup device, the backup can be interrogated, such as on a file basis and/or a block-by-block basis for example, and the infected file list may be updated based on the outcome of the interrogation. In an embodiment, the interrogation process may utilize the crawling method, or the change block method.

In an embodiment, the infected file list may be created, appended, or updated, using any combination of these aforementioned methods for building an infected file list. The infected file status, depending on the application requirements, may contain more than one value. For example, if a change block is determined to have a high entropy, such as may indicate that the block may have been encrypted by ransomware for example, and the extension of the suspect changed file has a well known ransomware extension, such as * wannacry, then this combination of indicators may suggest two infected statuses. Multiple infected statuses may, in turn, indicate a relative increase in confidence that the file is infected. That is, for example, two ‘infected’ statuses may indicate a higher level of confidence that a file is infected, than if that file has only one ‘infected’ status.

C.7 Restoring from a Potentially Infected Backup

Typical ransomware attacks target certain file types. The goal is to ransom critical data. If the server is not functional after an attack, then there is no data to ransom. That is, the data has effectively been deleted. The idea of the attack is to have the server still operational and even continue to be backed up, thereby infecting the backup copies as well. An effective ransomware attack would attack files of sufficient value to force the customer to pay the ransom. Then the victim hopes the attacker can find the attacked data and restore it to its uninfected state. This requires the server to be alive and healthy and the ransomware recovery software can enumerate the server and find attacked files, restoring them to their uninfected state, usually in the form of decoding/decryption.

In many, if not most, circumstances, it is quite likely that not all the data in the latest backup is infected. If the owner were to restore to the last known good backup, that backup may be quite old and, as a result, a much larger data loss event would occur. That is, the changes in the data increase the further back in time, after the most recent backup, that a backup is taken. Thus, restoring to a backup taken 2 days ago would result in a relatively smaller data loss than restoring to a backup taken 6 months ago. The ideal would be to restore all the latest uninfected data and just recover the last known good copy of each of the infected files. This approach may involve going back multiple backups until an uninfected copy can be found.

### C.8 Sandbox Isolation

Often, after an attack, such as a ransomware attack, there is necessary caution and concern of further spreading and damage by the attack. Thus, an embodiment may perform restoration to a sandbox or isolation area where the restore results can be verified and possibly re-scanned. In general, a sandbox may be a computing environment that is isolated, such as by an air gap for example, so that once the backup is restored to the sandbox, and the sandbox isolated, no data or code can enter or leave the sandbox. Thus, if a particular backup is infected, an embodiment may restore this backup to an isolated environment prior to going into production or before selectively recovering data. The sandbox may be managed tightly and may not be easily accessible by the production network where normal operations, such as data creation and backup, are being performed.

### C.9 Automated Recovery of Latest Known Good Copies

An embodiment may comprise an automated process for recovering last known good copies of files or other datasets. Such automation may be implemented where the restore destination for a backup is a temporary or isolated copy. In the automated use case, the backup may be copied to an isolation area such as a sandbox, the infected file list enumerated, and all the associated blocks with each infected file written to the target disk as zeros. This effectively erases any infection in the file. Once the backup has been cleaned in this way, the last known good copies of each of the infected files may be retrieved from previous backups and restored. In an embodiment, a report may be generated, possibly automatically, that includes information such as, but not limited to: (1) which file (or files) was infected; reason(s) why the file was designated as ‘infected” (3) the backup date of the backup from which the last known good copy of the file was retrieved; and (4) the restore status of the file, that is, if the file has been restored, and if so, when and from which backup.

### C.10 Selectively Restoring Last Known Good Copies

In an embodiment, the data owner or other user may not want to risk restoring a backup that has been infected and would rather use a cherry-pick restore process, as disclosed herein, to (a) recover certain files from the infected backup and (b) identify last know good copies of particular files. In an embodiment, a selective restore process may be manual and interactive, and may involve a user using a UI to select particular files and copies for restoration. In some circumstances, this manual process may be slower, but more flexible, than an automatic restore process.

### D. FURTHER DISCUSSION

As will be apparent from this disclosure, one or more embodiments may possess various useful features and aspects. However, no embodiment is required to possess any of such features and aspects. The following examples are illustrative.

An embodiment may certify backups as being ransomware free with a high level of confidence. This may be of particular value if these are backups are placed on write-once media. As another example, and embodiment may employ post processing forensics that may be be run against data retrieved from an infected backup to ensure the integrity of that data, and take appropriate remedial action where the integrity is questionable.

### E. EXAMPLE METHODS

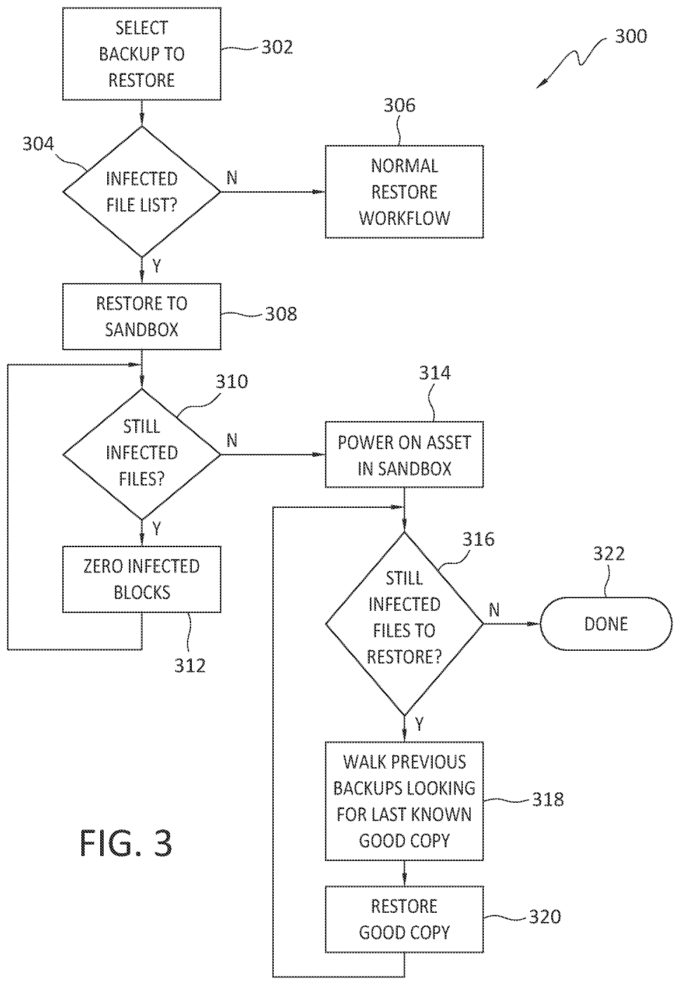

It is noted with respect to the disclosed methods, including the example methods of FIGS. 1 and 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In an embodiment, any of the disclosed methods may be performed in whole, or in part, by a data protection application and/or restore application, such as a backup application for example. In an embodiment, any of the disclosed methods may be performed in whole, or in part, by a plugin, such as a plugin to a data protection application and/or restore application for example. No particular implementation of any of the disclosed methods is required however. In an embodiment, a data protection application may perform both data protection operations, and data restore operations.

With reference now to FIG. 3, a method according to one embodiment is denoted at 300. The example method 300 may begin with selection 302, by a user or automatically, of a backup to be restored. A check 304 may then be performed to determine if the backup has, or is otherwise associated with, an infected file list. If not, indicating that no files in the backup have been compromised, the method 300 may move ahead with a normal backup restore workflow 306.

On the other hand, if an infected file list is determined 304 to exist for the selected backup, that backup may then be restored 308 to an isolated environment, such as a sandbox. In the sandbox, the files may be checked 310 to confirm they are in fact infected. If so, infected areas of the files on the infected file list may be neutralized, such as by a zero out process 312.

The operations 310 and 312 may be performed recursively for all the files in the backup until a check 310 indicates no remaining files of the backup are infected, at which point, the asset may be powered on 314 in the sandbox.

Next, a further check 316 may be performed to determine if there are any infected files on the asset, from which the backup was taken that was restored 308 to the sandbox, and to which the selected 302 back is ultimately to be restored, that are to be restored. If so, the method 300 may proceed to 318 where the backups of those infected files are walked 318 until a last known good copy of each file is found. For each file, the respective last known good copy may then be restored 320. Thus, the operations 316, 318, and 320, may be performed recursively until the check 316 reveals that there are no remaining infected files on the asset. At this point, the method 300 may then terminate 322.

### F. FURTHER EXAMPLE EMBODIMENTS

Following are some further example embodiments of the invention. These are presented only by way of example and are not intended to limit the scope of the invention in any way.

Embodiment 1. A method, comprising: selecting a backup for restoration to a target asset; when an examination of the backup reveals that the backup is associated with an infected file list, restoring the backup to a sandbox; in the sandbox, zeroing out any infected blocks of any infected files of the backup that are listed in the infected file list; restoring the backup from the sandbox to the target asset; and/or restoring to the target asset, a respective last known good version of selected ones of the infected files.

Embodiment 2. The method as recited in any preceding embodiment, wherein when the infected file list is encountered, presenting a user an option to restore one or more files of the backup to a location other than the target asset.

Embodiment 3. The method as recited in any preceding embodiment, wherein the backup comprises the infected file list, a changed file list, and a hierarchical catalog file list.

Embodiment 4. The method as recited in embodiment 3, wherein each of the infected file list, the changed file list, and the hierarchical catalog file list, comprises a discrete respective data structure.

Embodiment 5. The method as recited in any preceding embodiment, wherein the last known good version(s) are restored automatically.

Embodiment 6. The method as recited in any preceding embodiment, wherein after the last known good version(s) are identified, a report is generated that indicates: the infected file(s) were infected; for each file, a reason that the file was designated as infected; a date of a backup in which a respective one of the last known good versions was determined to exist; and, a respective restore status for each of the infected files.

Embodiment 7. The method as recited in any preceding embodiment, wherein the respective last known good versions are identified to a user by way of a user interface that enables user selection, on an individual basis, of the last known good versions.

Embodiment 8. The method as recited in any preceding embodiment, wherein one of the infected files indicates that a ransomware attack has taken place.

Embodiment 9. The method as recited in any preceding embodiment, wherein the backup comprises a changed file list that comprises a list of files that have changed since an earlier backup, preceding the backup, was taken.

Embodiment 10. The method as recited in any preceding embodiment, wherein the respective last known good versions are restored over those infected files whose infected blocks were zeroed out.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

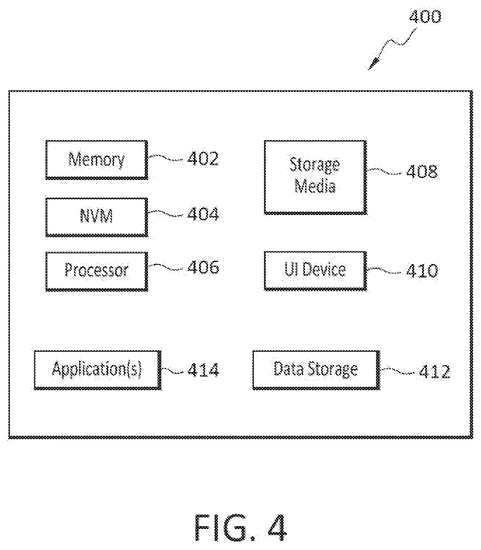

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
selecting a backup for restoration to a target asset;
when an examination of the backup reveals that the backup is associated with an infected file list, restoring the backup to a sandbox;
in the sandbox, zeroing out any infected blocks of any infected files of the backup that are listed in the infected file list;
restoring the backup from the sandbox to the target asset; and/or
restoring to the target asset, a respective last known good version of selected ones of the infected files.

2. The method as recited in claim 1, wherein when the infected file list is encountered, presenting a user an option to restore one or more files of the backup to a location other than the target asset.

3. The method as recited in claim 1, wherein the backup comprises the infected file list, a changed file list, and a hierarchical catalog file list.

4. The method as recited in claim 3, wherein each of the infected file list, the changed file list, and the hierarchical catalog file list, comprises a discrete respective data structure.

5. The method as recited in claim 1, wherein the last known good version(s) are restored automatically.

6. The method as recited in claim 1, wherein after the last known good version(s) are identified, a report is generated that indicates: the infected file(s) were infected; for each file, a reason that the file was designated as infected; a date of a backup in which a respective one of the last known good versions was determined to exist; and, a respective restore status for each of the infected files.

7. The method as recited in claim 1, wherein the respective last known good versions are identified to a user by way of a user interface that enables user selection, on an individual basis, of the last known good versions.

8. The method as recited in claim 1, wherein one of the infected files indicates that a ransomware attack has taken place.

9. The method as recited in claim 1, wherein the backup comprises a changed file list that comprises a list of files that have changed since an earlier backup, preceding the backup, was taken.

10. The method as recited in claim 1, wherein the respective last known good versions are restored over those infected files whose infected blocks were zeroed out.

11. A non-transitory storage medium having stored therein instructions that are executable by one or more hardware processors to perform operations comprising:
selecting a backup for restoration to a target asset;
when an examination of the backup reveals that the backup is associated with an infected file list, restoring the backup to a sandbox;
in the sandbox, zeroing out any infected blocks of any infected files of the backup that are listed in the infected file list;
restoring the backup from the sandbox to the target asset; and/or
restoring to the target asset, a respective last known good version of selected ones of the infected files.

12. The non-transitory storage medium as recited in claim 11, wherein when the infected file list is encountered, presenting a user an option to restore one or more files of the backup to a location other than the target asset.

13. The non-transitory storage medium as recited in claim 11, wherein the backup comprises the infected file list, a changed file list, and a hierarchical catalog file list.

14. The non-transitory storage medium as recited in claim 13, wherein each of the infected file list, the changed file list, and the hierarchical catalog file list, comprises a discrete respective data structure.

15. The non-transitory storage medium as recited in claim 11, wherein the last known good version(s) are restored automatically.

16. The non-transitory storage medium as recited in claim 11, wherein after the last known good version(s) are identified, a report is generated that indicates: the infected file(s) were infected; for each file, a reason that the file was designated as infected; a date of a backup in which a respective one of the last known good versions was determined to exist; and, a respective restore status for each of the infected files.

17. The non-transitory storage medium as recited in claim 11, wherein the respective last known good versions are identified to a user by way of a user interface that enables user selection, on an individual basis, of the last known good versions.

18. The non-transitory storage medium as recited in claim 11, wherein one of the infected files indicates that a ransomware attack has taken place.

19. The non-transitory storage medium as recited in claim 11, wherein the backup comprises a changed file list that comprises a list of files that have changed since an earlier backup, preceding the backup, was taken.

20. The non-transitory storage medium as recited in claim 11, wherein the respective last known good versions are restored over those infected files whose infected blocks were zeroed out.
